(19) United States
(12) Patent Application Publication
(10) Pub. No.: US 2019/0155231 A1
(43) Pub. Date: May 23, 2019

(54) POWER MANAGEMENT SYSTEM

(71) Applicants: Inventec (Pudong) Technology Corporation, Shanghai (CN); INVENTEC CORPORATION, TAIPEI CITY (TW)

(72) Inventor: Ming-Lung WENG, TAIPEI CITY (TW)

(21) Appl. No.: 15/952,262

(22) Filed: Apr. 13, 2018

(30) Foreign Application Priority Data
Nov. 21, 2017 (CN) 201711166274.8

(51) Int. Cl. G05B 15/02; G06Q 50/06; H04L 29/08

(52) U.S. Cl. CPC G05B 15/02; H04L 67/12; G06Q 50/06

(57) ABSTRACT

A power management system includes a server, electronic device and a controller. The server is configured to download electricity price data. The controller is electrically connected with the electronic device, and is configured to communicate with the server. The controller is configured to activate the electronic device during a specific period according to a first control instruction generated, based on the electricity price data, by the server.

### CROSS-REFERENCE TO RELATED APPLICATION

This application claims priority to Chinese Application Serial Number 201711166274.8, filed on Nov. 21, 2017, which is herein incorporated by reference.

### BACKGROUND

### Field of Invention

The present disclosure relates to a power management system. More particularly, the present disclosure relates to a power management system employing the Internet of Things (IoT).

### Description of Related Art

The power management performed by a conventional power management system does not depend on electricity price supplied by an electric power company, so users cannot obtain an instant rate. Moreover, the conventional power management system cannot show consumed power of various electronic devices for the users. Based on above disadvantages of the conventional power management system, it is hard for the users to arrange plans of using power or saving power.

### SUMMARY

In an embodiment of the present disclosure, a power management system includes a server, an electronic device and a controller. The server is configured to download electricity price data. The controller is electrically connected with the electronic device, and is configured to communicate with the server. The controller is configured to activate the electronic device during a specific period according to a first control instruction generated, with the electricity price data, by the server.

In another embodiment of the present disclosure, a power management system includes a server, a hub, electronic devices and controllers. The server is configured to download electricity price data. The hub is electrically connected with the server. The controllers are connected with the electronic devices one to one, and are configured to communicate with the server via the hub. The controllers are configured to activate the corresponding electronic devices during specific periods according to first control instructions generated, with the electricity price data, by the server, respectively.

### BRIEF DESCRIPTION OF THE DRAWINGS

In order to more clearly illustrate the above and other object, features, advantages and embodiments of the present disclosure, the accompany drawings are as follows.

FIG. 1 is a block diagram of a power management system in accordance with an embodiment of the present disclosure; and

FIG. 2 is a block diagram of a power management system in accordance with other embodiment of the present disclosure.

### DETAILED DESCRIPTION

The following is cited embodiments accompanied with figures are described in detail, but the examples are not provided to limit the scope of the disclosure covered by the non-operation of the structure described in order to limit its implementation, any by the structure regrouping of the components, the device has equal efficacy to produce, it is all covered by the scope of the present disclosure.

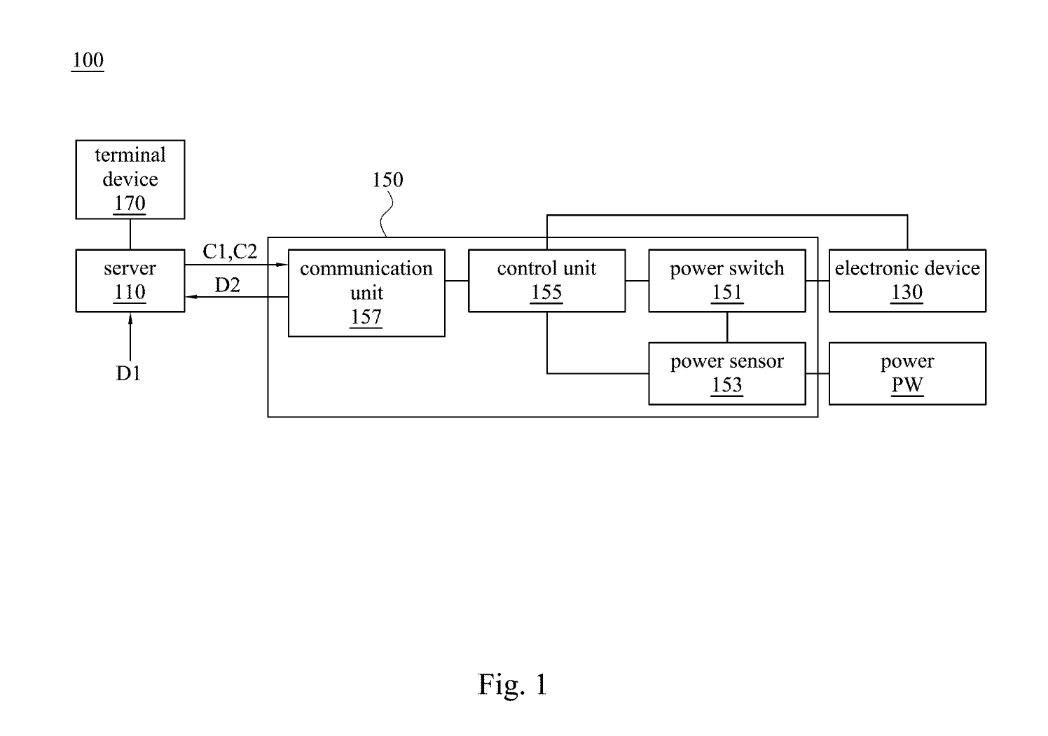

Referring to FIG. 1, FIG. 1 is a block diagram of a power management system 100 in accordance with an embodiment of the present disclosure.

The power management system 100 includes a server 110, an electronic device 130 and a controller 150. In another embodiment, the power management 100 further includes a terminal device 170.

The server 110 is configured to download electricity price data D1, wherein the electricity price data D1 may be an electricity price table.

Specifically, the server 110 may be connected to a website (or database) of an electric power company through an internet, and download the electricity price table from the website (or database) of the electric power company. In the electricity price table, the electricity price table includes data of the relationship between time periods and rate. For example, the rate of peak hours is five dollars per kilowatt hour, the rate of half-peak hours is three dollars per kilowatt hour, and the rate of off-peak hours is one dollar per kilowatt hour.

In an embodiment, the server 110 may be implemented by an IoT cloud server, a web server, an application program server, a file server or a database server, but the server 110 in this disclosure is not limited thereto.

The electronic device 130 is electrically connected with the controller 150, and the electronic device 130 is configured to receive electricity from a power PW through the controller 150. The electronic device 130 may be one of various devices using electricity, such as a washing machine, a television, a refrigerator, a microwave oven or an electric light for household, or an air conditioner, a server or a printer for enterprise.

The controller 150 is configured to communicate with the server 110, and the controller 150 is configured to activate the electronic device 130 during a specific period according to a first control instruction C1 generated, based on the electricity price data D1, by the server 110.

In detail, the controller 150 may include a power switch 151, a power sensor 153, a control unit 155 and a communication unit 157.

The power switch 151 is electrically connected with the electronic device 130, and the power switch 151 is configured to activate or deactivate the electronic device 130.

In an embodiment, the power switch 151 may be implemented by a metal oxide semiconductor field effect transistor (MOSFET) switch, a relay switch or an optocoupler relay switch, but the power switch 151 in this disclosure is not limited thereto.

The power sensor 153 is electrically connected with the power switch 151 and the power PW, and the power sensor 153 is configured to detect, by employing measurements such as a current measurement or a voltage measurement, consumed power of the electronic device 130 electrically connected to the power sensor 153.

In an embodiment, the power sensor 153 may be implemented by a micro power sensor or a waveguide power sensor, but the power sensor 153 in this disclosure is not limited thereto.

The control unit 155 is electrically connected with the power switch 151, the power sensor 153 and the electronic device 130.

The control unit 155 is configured to control the power switch 151 to activate or deactivate the electronic device 130 according to the first control instruction C1 generated, based on the electricity price data D1, by the server 110.

The control unit 155 is configured to control the power sensor 153 to detect, by employing the current measurement or the voltage measurement, the consumed power of the electronic device 130 electrically connected to the power sensor 153. After the power sensor 153 detects the consumed power of the electronic device 130 to generate sensing data D2, the sensing data D2 is outputted through the control unit 155.

The control unit 155 is configured to control an operation mode of the electronic device 130 according to a second instruction C2 generated by the server 110.

In an embodiment, the control unit 155 may be implemented by a microcontroller, a single chip microcomputer or a microcomputer, but the control unit 155 in this disclosure is not limited thereto.

The communication unit 157 is electrically connected with the control unit 155, and the communication unit 157 is configured to communicate with the serve 110, and to output the sensing data D2 to the server 110, for the users to reference. Thereby, the users can adjust power strategy and power setting according to the sensing data D2.

In an embodiment, the communication unit 157 may be a Wi-Fi communication module, a Bluetooth communication module or a Zigbee communication module, but the communication unit 157 in this disclosure is not limited thereto.

The terminal device 170 is configured to communicate with the server 110 to monitor the sensing data D2 of the electronic device 130 through the server 110. That is, the users can directly monitor the sensing data D2 of the electronic device 130 through the terminal device 170, and it is convenient for the users. In an embodiment, the terminal device 170 may be a smart phone, notebook, a tablet computer or a personal computer, but the terminal device 170 in this disclosure is not limited thereto.

A first application of the power management system 100 will be described below, wherein the server 110 is illustrated, for example, as the IoT cloud server, the electronic device 130 is illustrated, for example, as the washing machine, the power switch 151 of the controller 150 is illustrated, for example, as the MOSFET switch, the power sensor 153 of the controller 150 is illustrated, for example, as the microwave power sensor, the control unit 155 of the controller 150 is illustrated, for example, as the microcontroller, the communication unit 157 of the controller 150 is illustrated, for example, as the Wi-Fi communication module, the power PW is illustrated, for example, as mains electricity, the terminal device 170 is illustrated, for example, as the smart phone, the electricity price data D1 is illustrated, for example, as the electricity price table, and the sensing data D2 is illustrated, for example, as a consumed power data of the washing machine.

First, the IoT cloud server is connected to the website (or database) of the electric power company through the internet, and download the electricity price table from the website (or database) of the electric power company. In the electricity price table, the electricity price table includes data of the relationship between time periods and rate. For example, the rate of peak hours is five dollars per kilowatt hour, the rate of half-peak hours is three dollars per kilowatt hour, and the rate of off-peak hours is one dollar per kilowatt hour.

Then, the first control instruction C1 may be generated by the IoT cloud server based on the electricity price table by a manual operation or an automatic operation. In the example, compared with the rate of the peak hours which is five dollars per kilowatt hour and the rate of the half-peak hours which is three dollars per kilowatt hour, the rate of the off-peak hours, which is one dollar per kilowatt hour, is the cheapest. To save money on electricity bills, the first control instruction C1 may be a control instruction of “activate during the off-peak hours”.

Afterwards, the microcontroller configured in the washing machine is configured to receive the control instruction of “active during the off-peak hours” through the Wi-Fi communication module, and the washing machine is activated by controlling the MOSFET switch during “the off-peak hours”, and the washing machine will receive power of the mains electricity to be operated.

Therefore, the washing machine can be operated under the cheapest rate to save money on electricity bills.

Moreover, when the washing machine is operated, the microwave power sensor configured in the washing machine may sense the consumed power of the washing machine and generate the consumed power data. Then, the microcontroller of the washing machine is configured to output the consumed power data to the IoT cloud server through the Wi-Fi communication module for the users to reference. Further, the users can directly monitor the consumed power data and history consumed power data, and adjust power strategy and power setting. It is convenient for the users.

A second application of the power management system 100 will be described below, wherein the electronic device 130 is illustrated, for example, as the refrigerator, and examples of the server 110, the power switch 151 of the controller 150, the power sensor 153 of the controller 150, the control unit 155 of the controller 150, the communication unit 157 of the controller 150, the power PW, the terminal device 170 and the electricity price data D1 are the same as corresponding components of the first application, and the sensing data D2 is illustrated, for example, as the consumed power of the refrigerator.

First, the IoT cloud server is connected to the website (or database) of the electric power company through the internet, and download the electricity price table from the website (or database) of the electric power company. In the electricity price table, the electricity price table includes data of the relationship between time periods and rate. For example, the rate of peak hours is five dollars per kilowatt hour, the rate of half-peak hours is three dollars per kilowatt hour, and the rate of off-peak hours is one dollar per kilowatt hour.

Then, the first control instruction C1 may be generated by the IoT cloud server based on the electricity price table by the manual operation or the automatic operation. In the example, the rate of the off-peak hours which is one dollar per kilowatt hour is compared with the rate of the peak hours which is five dollars per kilowatt hour and the rate of the half-peak hours which is three dollars, the rate of the off-peak hours is the cheapest, so in order to save money on electricity bills, the second control instruction C2 may be a control instruction of “activate an ice making mode during the off-peak hours”.

Afterwards, the microcontroller configured in the refrigerator is configured to receive the control instruction of “active the ice making mode during the off-peak hours” through the Wi-Fi communication module, and the ice making mode of the refrigerator is activated during “the off-peak hours”.

Therefore, the refrigerator can be operated under the cheapest rate to save money on electricity bills.

Moreover, when the refrigerator is operated, the microwave power sensor configured in the refrigerator may sense the consumed power of the refrigerator and generates the consumed power data. Then, the microcontroller of the refrigerator is configured to output the consumed power data to the IoT cloud server through the Wi-Fi communication module for the users to reference. Further, the users can directly monitor the consumed power data and history consumed power data, and adjust power strategy and power setting by the smart phone. It is convenient for the users.

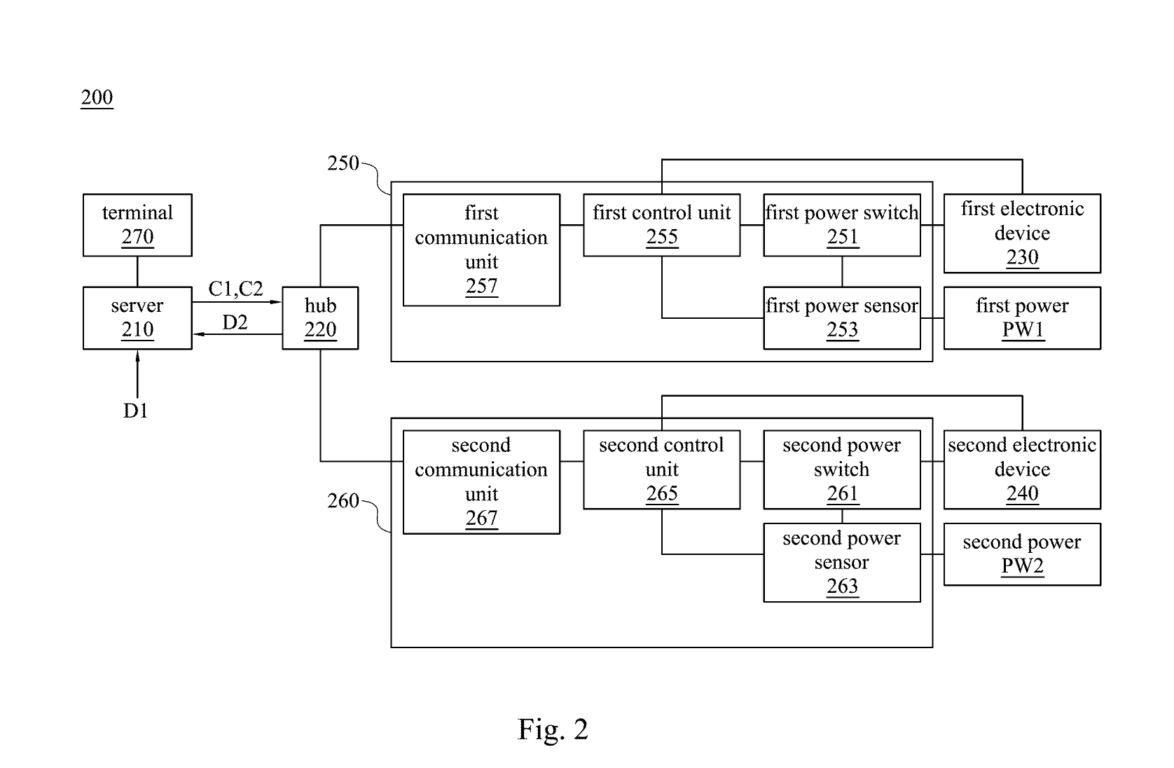

Referring to FIG. 2, FIG. 2 is a block diagram of a power management system 200 in accordance with other embodiment of the present disclosure.

The power management system 200 includes a server 210, a hub 220, two electronic devices (a first electronic device 230 and a second electronic 240) and two controllers (a first controller 250 and a second controller 260). In another embodiment, the power management system 200 further comprises a terminal device 270.

It should be noted that the number of the electronic devices and the controllers are examples, but the number of the electronic devices and the controllers in this disclosure are not limited thereto. That is, the number of the electronic devices and the controllers may be more than two.

The server 210 is configured to download electricity price data D1, wherein the electricity price data D1 may be the electricity price table. Functions and structure of the server 210 is the same as functions and structure of the server 110, so the functions and the structure of the server is not necessary to repeat in detail.

The hub 220 is electrically connected with the server 210.

In an embodiment, the hub 220 may be an IoT hub, but the hub 220 in this disclosure is not limited thereto.

The first electric device 230 is electrically connected with the first controller 250, and the first electric device 230 is configured to receive electricity from a first power PW1 by the first controller 250. The first electronic device 230 may be one of various devices using electricity, such as the washing machine, the television, the refrigerator, the microwave oven or the electric light for household, or the air conditioner, the server or the printer for enterprise.

The second electric device 240 is electrically connected with the second controller 260, and the second electric device 240 is configured to receive electricity from a second power PW2 by the second controller 260. The second electronic device 240 may be one of various devices using electricity, such as the washing machine, the television, the refrigerator, the microwave oven or the electric light for household, or the air conditioner, the server or the printer for enterprise.

The first controller 250 is configured to communicate with the server 210, and the first controller 250 is configured to activate the first electronic device 230 during the specific period according to the first control instruction C1 generated, based on the electricity price data D1, by the server 210.

In detail, the first controller 250 may include a first power switch 251, a first power sensor 253, a first control unit 255 and a first communication unit 257.

Functions and structure of the first power switch 251, the first power sensor 253, the first control unit 255 and the first communication unit 257 of the first controller 250 are almost the same as functions and structure of the power switch 151, the power sensor 153, the control unit 155 and the communication unit 157 of the controller 150 in FIG. 1, so the functions and the structure of the first power switch 251, the first power sensor 253, the first control unit 255 and the first communication unit 257 of the first controller 250 are not necessary to repeat in detail.

The terminal device 270 is configured to communicate with the server 210 to monitor the sensing data D2 of the first electronic device 230 through the server 210. Functions and structure of the terminal device 270 is almost the same as the terminal device 170 in FIG. 1, so the terminal device 270 is not necessary to repeat in detail.

The second controller 260 is configured to communicate with the server 210, and the second controller 260 is configured to activate the second electronic device 240 during the specific period according to the first control instruction C1 generated, based on the electricity price data D1, by the server 210.

In detail, the second controller 260 may include a second power switch 261, a second power sensor 263, a second control unit 265 and a second communication unit 267.

Functions and structure of the second power switch 261, the second power sensor 263, the second control unit 265 and the second communication unit 267 of the second controller 260 are almost the same as the functions and the structure of the power switch 151, the power sensor 153 and the control unit 155 and the communication unit 157 of the controller 150 in FIG. 1, so the functions and the structure of the second power switch 261, the second power sensor 263, the second control unit 265 and the second communication unit 267 of the second controller 260 are not necessary to repeat in detail.

A first application of the power management system 200 will be described below, wherein the server 210 is illustrated, for example, as the IoT cloud server, the first electronic device 230 is illustrated, for example, as the washing machine, the second electronic device 240 is illustrated, for example, as the refrigerator, the first power switch 251 of the first controller 250 and the second power switch 261 of the second controller 260 are illustrated, for example, as the MOSFET switches, the first power sensor 253 of the first controller 250 and the second power sensor 263 of the second controller 260 are illustrated, for example, as the microwave power sensors, the first control unit 255 of the first controller 250 and the second control unit 265 of the second controller 260 are illustrated, for example, as the microcontrollers, the first communication unit 257 of the first controller 250 and the second communication unit 267 of the second controller 260 are illustrated, for example, as the Wi-Fi communication modules, the first power PW1 and the second power PW2 are illustrated, for example, as mains electricity, the terminal device 270 is illustrated, for example, as the smart phone, the electricity price data D1 is illustrated, for example, as the electricity price table, and the sensing data D2 is illustrated, for example, as a consumed power data of the washing machine or the refrigerator.

First, the IoT cloud server is connected to the website (or database) of the electric power company through the internet, and download the electricity price table from the website (or database) of the electric power company. In the electricity price table, the electricity price table includes data of the relationship between time periods and rate. For example, the rate of peak hours is five dollars per kilowatt hour, the rate of half-peak hours is three dollars per kilowatt hour, and the rate of off-peak hours is one dollar per kilowatt hour.

Then, the first control instruction C1 or the second control instruction C2 may be generated by the IoT cloud server based on the electricity price table by the manual operation or the automatic operation. In the example, the rate of the off-peak hours which is one dollar per kilowatt hour is compared with the rate of the peak hours which is five dollars per kilowatt hour and the rate of the half-peak hours which is three dollars, the rate of the off-peak hours is the cheapest, so in order to save money on electricity bills, the first control instruction C1 may be the control instruction of “activate during the off-peak hours”, and the second control instruction C2 may be the control instruction of “activate the ice making mode during the off-peak hours”.

Afterwards, the microcontroller configured in the washing machine is configured to receive the control instruction of “active during the off-peak hours” through the Wi-Fi communication module, and the washing machine is activated by controlling the MOSFET switch during “the off-peak hours”, and the washing machine will receive power of the mains electricity to be operated.

Therefore, the washing machine can be operated under the cheapest rate to save money on electricity bills.

Furthermore, the microcontroller configured in the refrigerator is configured to receive the control instruction of “active the ice making mode during the off-peak hours” through the Wi-Fi communication module, and the ice making mode of the refrigerator during “the off-peak hours”.

Therefore, the refrigerator can be operated in high power consumption under the cheapest rate to save money on electricity bills.

Moreover, when the washing machine is operated, the microwave power sensor configured in the washing machine may sense the consumed power of the washing machine and generate the consumed power data; when the refrigerator is operated, the microwave power sensor configured in the refrigerator may sense the consumed power of the refrigerator and generate the consumed power data. Then, the microcontrollers of the washing machine and the refrigerator are configured to output the consumed power data to the IoT cloud server through the Wi-Fi communication module for the users to reference. Further, the users can directly monitor the consumed power data and history consumed power data, and adjust power strategy and power setting by the smart phone. It is convenient for the users.

In summary, the power management systems of the present disclosure are configured to activate the electronic devices with high power consumption or the operations of the devices during the specific period (e.g., the off-peak hours) based on the electricity price data by the server, the devices and the controller to save money on electricity bills. Moreover, the power management systems of the present disclosure are configured to further adjust power strategy and power setting by monitoring the sensing data of the electronic devices via the terminal device, and it is convenient for the users.

Although the case has been described above in Example revealed, however it is not intended to limit the present case, any skilled in the art, without departing from the spirit and scope of the case, when available for a variety of modifications and variations, and therefore the case Depending on the scope of protection of the rights after the appended claims and their equivalents.

What is claimed is:

1. A power management system, comprising:
a server configured to download electricity price data;
an electronic device; and
a controller electrically connected with the electronic device, and configured to communicate with the server, wherein the controller is configured to activate the electronic device during a specific period according to a first control instruction generated, based on the electricity price data, by the server.

2. The power management system of claim 1, wherein the controller comprises:
a power switch electrically connected with the electronic device;
a power sensor electrically connected with the power switch;
a control unit electrically connected with the power switch, the power sensor and the electronic device; and
a communication unit electrically connected with the control unit, and configured to communicate with the server.

3. The power management system of claim 2, wherein the power sensor is configured to generate a sensing data after sensing consumed power of the electronic device, and the control unit is configured to output the sensing data to the server via the communication unit.

4. The power management system of claim 3, further comprising a terminal device configured to communicate with the server to monitor the sensing data of the electronic device via the server.

5. The power management system of claim 1, wherein the controller is configured to control an operation mode of the electronic device according to a second instruction generated by the server.

6. A power management system, comprising:
a server configured to download electricity price data;
a hub electrically connected with the server;
electronic devices; and
controllers electrically connected with the electronic devices one to one, and configured to communicate with the server via the hub, wherein the controllers are configured to activate the corresponding electronic devices during specific periods according to first control instructions generated, based on the electricity price data, by the server, respectively.

7. The power management system of claim 6, wherein each of the controllers comprises:
a power switch electrically connected with the electronic device;
a power sensor electrically connected with the power switch;
a control unit electrically connected with the power switch, the power sensor and the electronic device; and
a communication unit electrically connected with the control unit, and configured to communicate with the server via the hub.

8. The power management system of claim 7, wherein the power sensor is configured to generate a sensing data after sensing consumed power of the electronic device, and the control unit is configured to output the sensing data to the server via the communication unit.

9. The power management system of claim 8, further comprising a terminal device configured to communicate with the server to monitor the sensing data of the electronic device via the server.

10. The power management system of claim 6, wherein the controller is configured to control an operation mode of the electronic device according to a second instruction generated by the server.
